(19) United States
(12) Patent Application Publication
(10) Pub. No.: US 2003/0084457 A1
(43) Pub. Date: May 1, 2003

(54) System and method for changing a name in TV program to a name requested by TV viewer

(75) Inventors: Gwi-ho Lee, Seoul (KR); Hee-seon Park, Seoul (KR); Hye-ju Kim, Incheon Metropolitan (KR); Young-kyu Jin, Goyang-si (KR)

Correspondence Address: SUGHRUE MION, PLLC, 2100 Pennsylvania Avenue, NW, Washington, DC, 20037-3213, US

(73) Assignee: Samsung Electronics Co., Ltd.

(21) Appl. No.: 10/237,269

(22) Filed: Sep. 9, 2002

(30) Foreign Application Priority Data
Sep. 8, 2001 (KR) 2001-55329

(51) Int. Cl. H04N 7/173; G06F 3/00; H04N 5/445; G10L 15/00; G10L 11/00; G10L 21/00; G10L 15/18; H04N 7/16; G06F 13/00

(52) U.S. Cl. 725/117; 725/38; 725/147; 704/275; 704/257

(57) ABSTRACT

A system and method for changing a name contained in a TV program being broadcast to a name requested by a TV viewer and providing the TV program containing the changed name are provided. The digital broadcast system includes a digital content receiver belonging to a user requesting a name change service; and a digital broadcast server for broadcasting a TV program to the digital content receiver, and if changing a name contained in the TV program to a different name is requested, providing the TV program containing a changed name to the digital content receiver. The TV viewer can watch a TV program in which original names are replaced by the viewer's name or acquaintances' names.

### BACKGROUND OF THE INVENTION

1. Field of the Invention

The present invention relates to a system and method for changing a name spoken in a TV program being broadcast to a name requested by a TV viewer and providing the TV program containing the changed name. The present application is based on Korean Application No. 2001-55329, filed Sep. 8, 2001, which is incorporated herein by reference.

2. Description of the Related Art

In general, TV viewers watch TV programs as broadcast by broadcasting stations. So-called customized televisions are known. However, customization capabilities of such televisions are limited to reserving channels preferred by a user. This cannot truly be characterized as a customized television which can satisfy each viewer watching the television. As digital TVs are today in wide use, demand for truly customized TVs is growing and such TVs that can satisfy users' needs are desired.

### SUMMARY OF THE INVENTION

To solve the above problems, it is a first objective of the present invention to provide a digital broadcast system for changing a name spoken in a TV program being broadcast to a name desired by a TV viewer and providing the TV program containing the changed name, and a method for providing the TV program containing the changed name.

It is a second objective of the present invention to provide a digital content receiver capable of changing a name spoken in a TV program being broadcast as digital content to a name desired by a TV viewer.

It is a third objective of the present invention to provide a method for changing a name spoken in a TV program being broadcast, from the digital content receiver.

It is a fourth objective of the present invention to provide a digital content reproducer for reproducing digital content stored in a predetermined recording medium, changing a name spoken in the digital content to a name desired by a user, and providing the digital content containing the changed name.

To accomplish the first objective of the present invention, there is provided a digital broadcast system comprising a digital content receiver belonging to a user requesting a name change service; and a digital broadcast server for broadcasting a TV program to the digital content receiver, and if changing a name contained in the TV program to a different name is requested, providing the TV program containing a changed name to the digital content receiver.

Also, to accomplish the first objective of the present invention, there is provided a method for providing a service for changing names in a TV program in a digital broadcast system including a digital content receiver and a digital broadcast server for providing a TV program to the digital content receiver, in which a name contained in a TV program which is provided by a digital broadcast server to a digital content receiver is changed to a name desired by a user, the method comprising (a) providing an input screen to the digital content receiver if a name change service for changing a name contained in a TV program being broadcast to a different name is requested by the digital content receiver; (b) receiving an original name contained in the TV program and a desired object name which are input through the input screen from the digital content receiver; and (c) transmitting the TV program in which the object name replaces the original name, to the digital content receiver.

To accomplish the second objective of the present invention, there is provided a digital content receiver for receiving a TV program broadcast by a broadcasting station comprising a program changing unit for changing a name contained in the TV program to a different name, which is requested by a user, by the user's control.

To accomplish the third objective of the present invention, there is provided a method for changing names in a program in a digital content receiver for receiving digital content transmitted from the outside and displaying the digital content, in which a name contained in the digital content is changed to a different name, the method comprising (a) displaying changeable names among names contained in the digital content if a service for changing a name contained in the digital content to a different name is requested; (b) receiving an original name and a desired object name which are input; and (c) changing the selected original name to the input object name in the digital content.

To accomplish the fourth objective of the present invention, there is provided a digital content reproducer for storing and reproducing digital content comprising a program changing unit for changing a name contained in the digital content to a different name, which is input by a user, by external control when the stored digital content is reproduced.

### BRIEF DESCRIPTION OF THE DRAWINGS

The above objects and advantages of the present invention will become more apparent by describing in detail preferred embodiments thereof with reference to the attached drawings in which:

FIG. 1 is a schematic diagram of a digital broadcast system according to the present invention in which a name contained in a TV broadcast program is changed to a name requested by a TV viewer and the changed name is provided;

FIG. 2 is a flowchart of an embodiment of a method for changing a name contained in a TV broadcast program broadcast by the digital broadcast system of FIG. 1 to a name requested by a TV viewer; and

FIGS. 3(A) through 3(C) are examples of scenes displayed on a digital TV shown in FIG. 1 when the method of FIG. 2 is performed.

### DESCRIPTION OF THE PREFERRED EMBODIMENTS

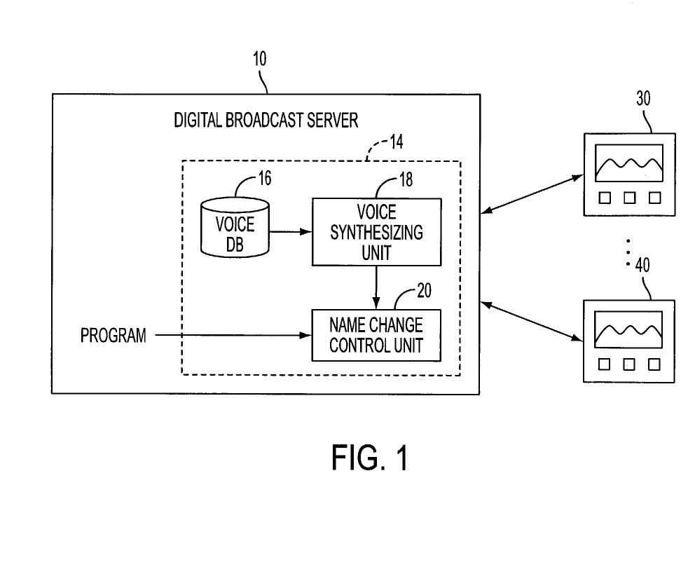

The digital broadcast system of FIG. 1 includes a digital broadcast server 10 and a plurality of digital content receivers 30 through 40.

Referring to FIG. 1, the plurality of digital content receivers 30 through 40 belong to users who request services for changing a name contained in a TV program being broadcast from the digital broadcast server 10 to a desired name. Here, the digital content receivers 30 through 40 are apparatuses for receiving a broadcast provided by the digital broadcast server 10 such as digital TV stations or Internet TV stations, and reproducing the received broadcast.

In response to a request of, for example, a digital content receiver 30 among the plurality of digital content receivers 30 through 40, the digital broadcast server 10 changes a name contained in a TV program being broadcast to a name requested by the user, and provides the TV program containing the changed name to the digital content receiver 30. Preferably, the digital broadcast server 10 includes a program changing unit 14 formed with a voice database (DB) 16, a voice synthesizing unit 18, and a name change control unit 20.

The voice DB 16 stores voices of speakers in a TV program being broadcast.

When the digital content receiver 30 requests to change a name contained in a TV program being broadcast (hereinafter, referred to as an original name) to a different name (hereinafter, referred to as an object name), the voice synthesizing unit 18 extracts the voice of a speaker indicated by the digital content receiver 30 from the voice DB 16, and synthesizes the object name using the extracted speaker's voice.

The name change control unit 20 changes the original name in the TV program being broadcast to the object name synthesized in the voice synthesizing unit 18, and provides the TV program containing the changed name to the digital content receiver 30.

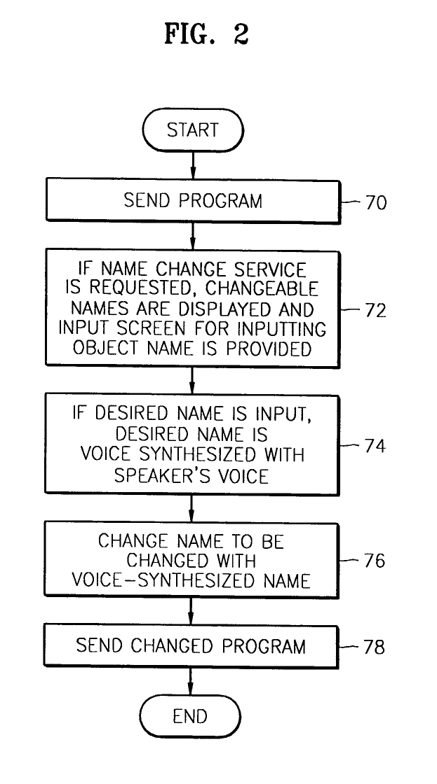

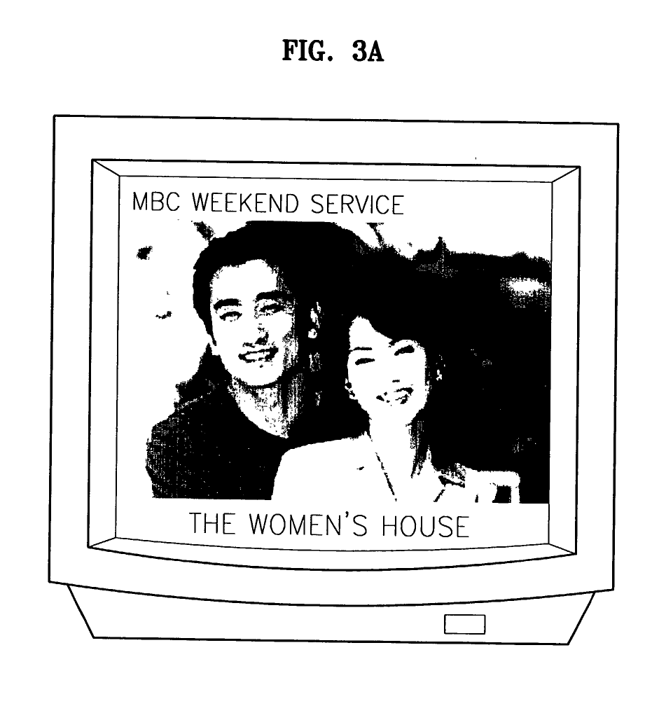

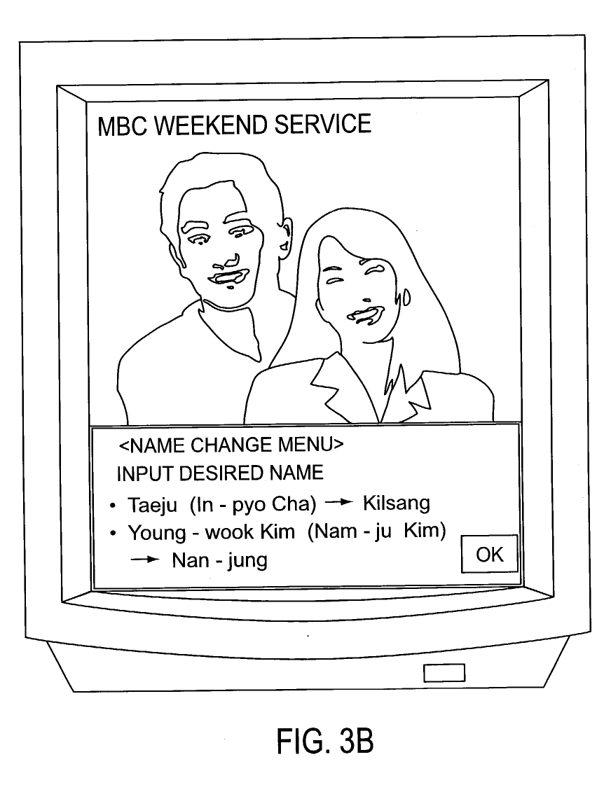

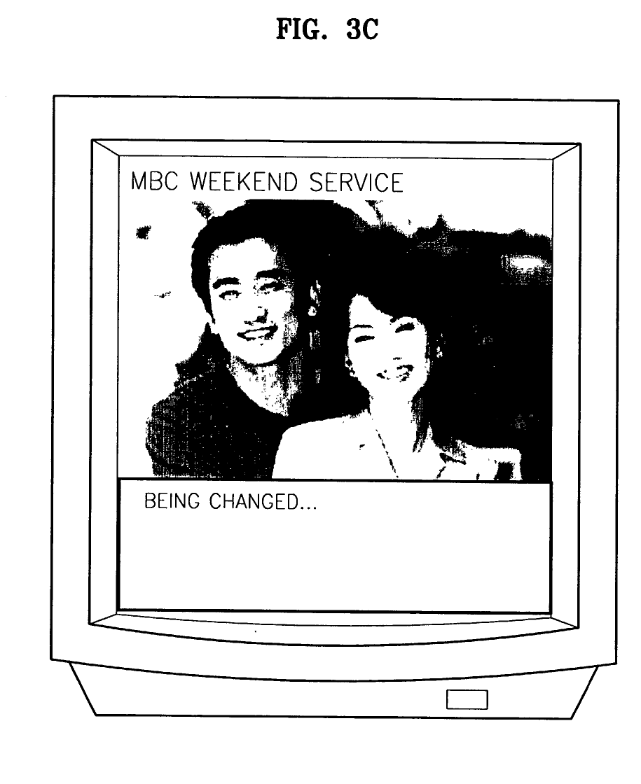

FIG. 2 is a flowchart of an embodiment of a method for changing a name contained in a TV broadcast program broadcast by the digital broadcast system of FIG. 1 to a name requested by a TV viewer. FIGS. 3(A) through 3(C) are examples of scenes displayed on a digital TV shown in FIG. 1 when the method of FIG. 2 is performed.

Referring to FIGS. 1 through 3, the detailed operations of the digital broadcast system shown in FIG. 1 will now be explained. If there is no request from, for example, the digital content receiver 30, the name change control unit 20 of the digital broadcast server 10 transmits a TV program (PG) to the digital content receiver without change in step 70. Therefore, on the screen of the digital content receiver 30 a scene as shown in FIG. 3(A) is displayed. At this time, if a name change service is requested by the digital content receiver 30, the name change control unit 20 provides an input screen as shown in FIG. 3(B) where original names in the TV program being broadcast which can be changed and input spaces for object names desired by the TV viewer are displayed in step 72. For example, as shown in FIG. 3(B), “Taeju” and “Young-wook Kim”, the original names in the TV program being broadcast which can be changed, are displayed on the screen.

After step 72, if the original names and object names are input from the digital content receiver 30, the voice synthesizing unit 18 extracts the voices of speakers who speak the original name from the voice DB 16 and synthesizes object names with the extracted voices in step 74. After step 74, the name change control unit 20 changes the portions in the TV program being broadcast where the original names desired to be changed are contained with the voice synthesized names in step 76, and transmits the TV program containing the changed names to the digital content receiver 30 in step 78. FIG. 3(C) shows a screen of the digital content receiver 30 for indicating that the names are being changed while the digital broadcast server 10 changes the names in step 76.

Referring to FIG. 3(B), it is assumed that the voice synthesizing unit 18 receives inputs of object names “Kilsang” corresponding to the original name “Taeju” and “Nan-jung” corresponding to the original name “Young-wook Kim”. Then, the voice synthesizing unit 18 extracts the voice of an actor who says “Taeju” and voice synthesizes “Kilsang” with the extracted voice. Also, the voice synthesizing unit 18 extracts the voice of an actor who says “Young-wook Kim” and voice synthesizes “Nan-jung”. The name change control unit 20 transmits the TV program in which the portions for “Taeju” and “Young-wook Kim” are replaced by voice synthesized “Kilsang” and “Nan-jung”, respectively, to the digital content receiver 30. Therefore, the TV viewer who watches the digital content receiver 30 can watch the TV program being broadcast in which the portions for “Taeju” and “Young-wook Kim” are replaced by voice synthesized “Kilsang” and “Nan-jung”. At this time, if the digital content receiver 40 does not request the name change service to the digital broadcast server 10, the digital broadcast server 10 broadcasts the TV program without change.

Watching a TV program being broadcast by the digital broadcast server 10, the TV viewer who watches the digital content receiver 30 can replace the names with the TV viewer's name or with the names of acquaintances' so that the TV viewer can watch the TV program with a more realistic feeling. In particular, in a remote education program which is broadcast by one teacher to a plurality of students, if each viewer's name is spoken instead of “students” or “everybody”, the viewer can watch the education program with more concentration and therefore the educational effect can be improved.

Meanwhile, the program changing unit 14 may be included in the digital content receiver 30. Also, though not shown in drawings, the program changing unit 14 of FIG. 1 may be included in a digital content reproducer which reproduces digital content stored in a recording medium. Here, the digital content reproducer includes a digital Personal Video Recorder (PVR) for recording digital content on a hard disc and reproducing digital content from a hard disc, and a Compact Disc Player (CDP) and a Digital Versatile Disc (DVD) for recording digital content on a compact disc and reproducing digital content from a compact disc.

The digital content receiver 30 receives an original TV program from the digital broadcast server 10, and changes names contained in the TV program by the program changing unit included in the digital content receiver 30. At this time, names which can be changed among names contained in the TV program can be provided by the digital broadcast server 10. Also, if a name change is requested when digital content stored in a hard disc or a compact disc is reproduced, the digital content reproducer changes a name contained in the digital content being reproduced and reproduces the digital content containing the changed name. At this time, names which can be changed among names contained in the digital content may be stored in advance in the recording medium.

The present invention may be embodied in a code, which can be read by a computer, on a computer readable recording medium. The computer readable recording medium may be any kind of recording apparatus on which computer readable data are stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can store and execute a computer readable code in a distributed mode.

So far, optimum embodiments are explained in the drawings and specification, and though specific terminologies are used here, they are included only to explain the present invention. Therefore, the present invention is not restricted to the above-described embodiments and many variations are possible within the spirit and scope of the present invention. The scope of the present invention is not determined by the description but by the accompanying claims.

As described above, according to the digital broadcast system and method for changing a name contained in a TV program by a TV viewer's request according to the present invention, the TV viewer can watch a TV program in which original names are replaced by the viewer's name or acquaintances' names. Therefore, the TV viewer can watch the TV program with more realistic feeling. Also, when watching a remote educational program, the viewer's name is spoken such that the viewer can watch the program with more concentration and the educational effect can be enhanced.

What is claimed is

1. A digital broadcast system comprising:
a digital content receiver; and
a digital broadcast server for broadcasting a TV program to the digital content receiver, such that the digital broadcast server changes an original name spoken in an original TV broadcast to a name specified by a user upon request of the user.

2. The digital broadcast system of claim 1, wherein the digital broadcast server comprises:
a database for storing voices of speakers in the original TV broadcast;
a voice synthesizing unit for extracting the voice of a speaker speaking a name from the database if changing the original name to the name specified by the user is requested, and synthesizing the specified name using the extracted voice of the speaker; and
a name change control unit for changing the original name to the name synthesized in the voice synthesizing unit, and providing the TV program containing the changed name to the digital content receiver.

3. A digital content receiver for receiving a TV program broadcast by a broadcasting station comprising:
a program changing unit for changing an original name spoken in the TV program to a different name, which is requested by a user, by the user's control.

4. The digital broadcast system of claim 3, further comprising:
a Personal Video Recorder (PVR) for storing and reproducing the TV program,
wherein the program changing unit changes the original name spoken in the TV program reproduced by the PVR to a different name input by the user.

5. The digital content receiver of claim 3, wherein the program changing unit comprises:
a database for storing voices of speakers in the TV program;
a voice synthesizing unit for extracting the voice of a speaker speaking a name from the database if changing the original name to the different name is requested by the user, and synthesizing the different name requested by the user by using the extracted voice of the speaker; and
a name change control unit for changing the original name spoken in the TV program to the name synthesized in the voice synthesizing unit, and controlling display of the program containing the changed name.

6. A digital content reproducer for storing and reproducing digital content comprising:
a program changing unit for changing a name spoken in the digital content to a different name, which is input by a user, by external control when the stored digital content is reproduced.

7. A method for providing a service for changing names in a TV program in a digital broadcast system including a digital content receiver and a digital broadcast server for providing a TV program to the digital content receiver, in which an original name spoken in a TV program which is provided by a digital broadcast server to a digital content receiver is changed to a name desired by a user, the method comprising the steps of:
(a) providing an input screen to the digital content receiver if a name change service for changing the original name spoken in the TV program being broadcast to a different name is requested by the digital content receiver;
(b) receiving the original name spoken in the TV program and a desired object name which are input through the input screen from the digital content receiver; and
(c) transmitting the TV program containing the object name replacing the original name, to the digital content receiver.

8. The method of claim 7, wherein on the input screen changeable names among names spoken in the TV program are displayed.

9. The method of claim 7, wherein the digital broadcast server synthesizes the object name by using the voice of a speaker speaking the original name in the TV program, and changes the original name in the TV program to the synthesized object name.

10. A computer readable medium having embodied thereon a computer program for enabling a computer to provide a service for changing names in a TV program in a digital broadcast system including a digital content receiver and a digital broadcast server for providing a TV program to the digital content receiver, in which an original name spoken in a TV program which is provided by a digital broadcast server to a digital content receiver is changed to a name desired by a user, the service comprising steps of:
(a) providing an input screen to the digital content receiver if a name change service for changing the original name spoken in the TV program being broadcast to a different name is requested by the digital content receiver;
(b) receiving the original name spoken in the TV program and a desired object name which are input through the input screen from the digital content receiver; and
(c) transmitting the TV program containing the object name replacing the original name, to the digital content receiver.

11. A method for changing names in a program in a digital content receiver for receiving digital content transmitted from outside the digital content receiver and displaying the digital content, in which an original name contained in the digital content is changed to a different name, the method comprising the steps of:
(a) displaying changeable names among names spoken in the digital content if a service for changing a name contained in the digital content to a different name is requested;
(b) receiving an original name and a desired object name which are input; and
(c) changing the selected original name to the input object name in the digital content.

12. The method of claim 11, wherein step (c) comprises:
(c1) synthesizing the object name by using the voice of a speaker speaking the selected original name in the digital content; and
(c2) replacing the selected original name in the digital content with the synthesized object name.

13. The method of claim 11, wherein the digital content is broadcast by a broadcasting station or reproduced by a digital content reproducer.

14. A computer readable medium having embodied thereon a computer program for enabling a computer to change names in a program in a digital content receiver for receiving digital content transmitted from outside the digital content receiver and displaying the digital content, in which an original name contained in the digital content is changed to a different name, the computer program enabling the computer to perform the steps of:
(a) displaying changeable names among names spoken in the digital content if a service for changing a name contained in the digital content to a different name is requested;
(b) receiving an original name and a desired object name which are input; and
(c) changing the selected original name to the input object name in the digital content.
